(19) United States
(12) Patent Application Publication
(10) Pub. No.: US 2012/0152511 A1
(43) Pub. Date: Jun. 21, 2012

(54) LHTES DEVICE FOR ELECTRIC VEHICLE, SYSTEM COMPRISING THE SAME AND METHOD FOR CONTROLLING THE SAME

(75) Inventors: CHIEN-LUNG CHANG, Taipei County (TW); PO-CHANG LIN, Taipei County (TW)

(73) Assignees: SUNNY GENERAL INTERNATIONAL CO., LTD., Taipei County (TW); PO-CHANG LIN, Taipei County (TW)

(21) Appl. No.: 12/968,642

(22) Filed: Dec. 15, 2010

(51) Int. Cl. B60H 1/00; F24F 7/00; F28D 19/00

(52) U.S. Cl. 165/202; 165/10; 236/49.1

(57) ABSTRACT

A latent heat thermal energy storage (LHTES) device for an electric vehicle (EV) comprises a chamber, a plurality of thermal conductivity enhancement units disposed in the chamber, and phase change material (PCM) filled in the chamber, allowing storage of coolness or thermal energy produced when the EV is being charged and retrieval of the coolness or thermal energy when the EV is driven to regulate the temperature of a passenger compartment of the EV. In addition, systems comprising LHTES devices and methods for controlling the same are also introduced.

### FIELD OF THE INVENTION

The present invention generally relates to latent heat thermal energy storage (LHTES) devices for heating, ventilating, and/or air-conditioning (HVAC) in electric vehicles (EVs), and more particularly to LHTES devices which are rechargeable with thermal energy as well as coolness and operable with or without using heat transfer fluid (HTF). In addition, the present invention also provides systems comprising the LHTES devices and methods for controlling the same.

### BACKGROUND OF THE INVENTION

Global warming and climate change are forcing humanity to take certain drastic actions in order to protect our living environments on earth. The electric vehicle industries have been one of the major developments in recent years to provide effective, economical viable fuel-saving and eco-friendly vehicles. Rising fuel prices and the pressing need to cut carbon dioxide (CO₂) emissions are two issues that the automotive industry must address and solve quickly. While a lot of new drive concepts are being developed, they will not be available on a mass scale in the near future. Therefore, it is essential to improve the overall efficiency of the internal combustion engine, not by making minor changes in the vehicles, but by proposing quantum steps forwards in terms of technology.

Thus, electric vehicles have to be introduced onto the market as part of an overall transport and energy concept rather than a stand-alone technology. There must be an integrated approach to power supply and demand (from electric vehicles), to ensure the energy efficiency. One of the major peak load demands in electric vehicles is the air-conditioning and heating operation which can consume a large amount of energy and greatly shorten trip range per charge of an EV. Therefore, in order to travel a long journey, energy saving and high energy storage in electric vehicles become important issues to power efficiency and energy management. It is the purpose of this invention to take advantage of LHTES to storage thermal energy (or coolness) in the charging mode of an EV and to retrieve the energy (or coolness) from the LHTES in the driving mode of an EV, such that the trip range per charge of an EV would not be affected with the same amount of battery capacity.

### SUMMARY OF THE INVENTION

In view of the above problem, it is a primary object of this invention to increase, decrease or maintain the temperature of a cabin or passenger compartment of an EV while not substantially consuming the electric energy stored in a battery pack of the EV.

It is another primary object of this invention to provide an LHTES device for an EV used to store coolness or thermal energy produced when the EV is being charged and to release the coolness or thermal energy to regulate the temperature of a passenger compartment of the EV when the EV is in operation.

It is still another primary object of this invention to provide an air-conditioning solution which can regulate the temperature of a cabin or passenger compartment of an EV to a comfortable extent without substantially compromising the trip range.

In one embodiment of this invention, an LHTES device for an EV comprises a chamber, a plurality of thermal conductivity enhancement units disposed in the chamber, and phase change material (PCM) filled in the chamber.

In another embodiment of this invention, a split-type low temperature LHTES system comprises a first LHTES device comprising a chamber, a plurality of thermal conductivity enhancement units disposed in the chamber, and PCM having a phase change temperature less than 5° C. filled in the chamber; and a second LHTES device in thermal connection with the first LHTES device, the second LHTES device comprising a chamber, a plurality of thermal conductivity enhancement units disposed in the chamber, PCM having a phase change temperature greater than 0° C. filled in the chamber, and a plurality of fins in thermal connection with the chamber.

In one embodiment of this invention, an air-conditioning system for providing thermally conditioned air into a cabin of an EV comprises a thermal energy generation apparatus; a first LHTES device filled with PCM in thermal connection with the thermal energy generation apparatus to store the thermal energy produced thereby; and a ventilation device for driving air through the first LHTES device, whereby the air is thermally conditioned, and into the cabin.

In still another embodiment of this invention, an air-conditioning system for providing thermally conditioned air into a cabin of an electric vehicle comprises the split-type low temperature LHTES system mentioned above; a thermal energy generation apparatus in thermal connection with the first LHTES device; and a ventilation device for driving air through the second LHTES device, whereby the air is thermally conditioned, and into the cabin. In one embodiment of this invention, a method of controlling the usage of at least one LHTES device of an electric vehicle containing PCM and thermal conductivity enhancement medium comprises: (a) obtaining at least one state parameter; (b) determining a usage mode of the LHTES device according to the state parameter collected; and (c) actuating at least one of a thermal energy generation apparatus, a fan, a air passage door, and a movement apparatus of the electric vehicle according to the usage mode of the LHTES.

Other objects, advantages and novel features of the present invention will become apparent from the following detailed description of the invention when considered in conjunction with the accompanying drawings.

### BRIEF DESCRIPTION OF THE DRAWINGS

To provide a more complete understanding of example embodiments and features and advantages thereof, reference is made to the following description, taken in conjunction with the accompanying figures, wherein like reference numerals represent like parts, in which:

FIG. 1 is an illustrative view of an LHTES device in one embodiment of this invention;

FIG. 2 is a partial exploded view of an LHTES device in one embodiment of this invention;

FIG. 3 is an illustrative view of an air-conditioning system in one embodiment of this invention;

FIG. 4 is an illustrative view showing the use of two LHTES devices in one embodiment for air conditioning;

FIG. 5 is an illustrative view of a split-type low temperature LHTES system in one embodiment of this invention;

FIG. 6 is an illustrative view of an LHTES device in one embodiment making use of an evaporator as a thermal energy generation apparatus;

FIG. 7 is an illustrative view of a split-type low temperature LHTES system in one embodiment of this invention;

FIG. 8 is a block diagram showing an embodiment of the air-conditioning system of this invention integrated into an EV;

FIG. 9 is a front view showing a control panel of one embodiment of this invention;

FIG. 10 is a table showing various system variables which may be used for the control of an air-conditioning system of one embodiment of this invention;

FIG. 11 is a flow diagram showing the control algorithm for the determination of the system mode in one embodiment of this invention;

FIG. 12 is a graph illustrating the relation between PCM temperature and time under different system modes;

FIG. 13 is a flow diagram showing the control algorithm for the determination of different types of the venting mode in one embodiment of this invention; and

FIG. 14 is a table showing the operation state of different actuators under different system modes.

### DETAILED DESCRIPTION OF THE PREFERRED EMBODIMENTS

Before addressing the details of embodiments described below, some terms are defined as follows:

For the purpose of this invention, the term “thermal energy” means a form of energy which can cause temperature increase or decrease or maintain the temperature of, for example, a cabin or a passenger compartment of an EV. Thermal energy generally refers to hot or heat, the energy used to increase a temperature, when it is used together with cold or coolness, the energy generally used to decrease a temperature, but it should be understood as encompassing hot, heat, cold, and coolness when used alone unless otherwise stated. For example, a thermal energy generation apparatus is an apparatus capable of generating thermal energy, including hot, heat, cold, or coolness, such as a vapor-compression refrigeration system, a CO₂-based compression refrigeration system, a secondary loop system, a gas refrigeration system, a thermoelectric cooler or heater, a positive temperature coefficient (PTC) heater, or a heating coil.

As used herein, the term “heat transfer” is used to describe the transfer of heat from a heat source to a heat sink and is applicable to both heating and cooling (e.g. refrigeration) systems. Accordingly, a heat transfer device is a device adapted to transfer hot, heat, cold, or coolness from a heat source, such as one LHTES device, to a heat sink, such as another LHTES device, and heat transfer fluid includes liquids, viscous materials, and vapor or gaseous heat transfer materials which flow at the operating temperature of a heat transfer device.

The term “thermoelectric module” as used herein refers to a thermoelectric cooler, heater or generator that functions as a heat pump. When an electric current is applied to a thermoelectric module, heat is moved from one side of it to the other, from which it can be removed by or transferred to a heat sink. In some embodiments, the cold side can be used to pump heat out of an object. In addition, if the current is reversed, the device can be used to pump heat into the object. In some embodiments, thermoelectric modules can be stacked to achieve an increase in the cooling and heating effects of heat pumping.

In this invention, “thermal conductivity enhancement units,” which may be selected from a group consisting of heat pipes, graphite, carbon, thermally conductive metal, and the combination thereof, are used to facilitate heat transfer of phase change material. In addition, the shape of the thermal conductivity enhancement units is not particularly limited, which may be plate, coil, filament, strip, fiber, powder, or foam. For the purpose of this invention, the thermal conductivity enhancement units, including carbon-fiber brushes, carbon-fiber chips, graphite foam, or aluminum foam for example, disclosed in the following documents are herein incorporated by reference in its entirety: U.S. Pat. No. 6,942,944 to Al-Hallaj, et al; J. Fukai, et al, “Thermal response in thermal energy storage material around heat transfer tubes: effect of additives on heat transfer rates,” Solar Energy, 75, (2003), 317-328; J. Fukai, et al, “Improvement of thermal characteristics of latent heat thermal energy storage units using carbon-fiber brushes: experiments and modeling,” International Journal of Heat and Mass Transfer, 46, (2003), 4513-4525.

The term “electric vehicle” as used herein is intended to include both “all electric” and “hybrid electric” vehicles. Hybrid electric vehicles differ from all electric vehicles in that they also include an internal combustion engine coupled in various ways with the vehicle's electric drive system. In addition, term “electric vehicle” generally refers to any vehicle that can run on electric power stored in a battery pack, such as cars, buses, trains, ships, aircrafts, etc. As used herein, the term “latent heat” refers, for example, to the energy released or absorbed by a chemical substance during a change of state that occurs without changing its temperature, meaning a phase transition such as the melting of ice or the boiling of water. Moreover, the term “latent heat” as used in this invention includes the following types: latent heat of fusion—the heat used to change a substance from a solid to a liquid; latent heat of solidification—the heat used to change a substance from a liquid to a solid; and latent heat of crystallization—the heat used to transition between amorphous and crystalline phases of a substance.

The term “phase change” used herein refers to a process in which a substance undergoes a phase change during the process. The term “phase change temperature” refers to the temperature at which a substance undergoes a phase change. The term “phase change material” refers to a material that uses phase change to absorb or release relatively large amounts of latent heat at a relatively constant temperature. Many examples of phase change material are well known in the art, including those disclosed by M. Farad, et al, “A review on phase change energy storage: materials and applications,” Energy Conversion and Management, 45, (2004), 1597-1615, which is incorporated by reference in its entirety herein.

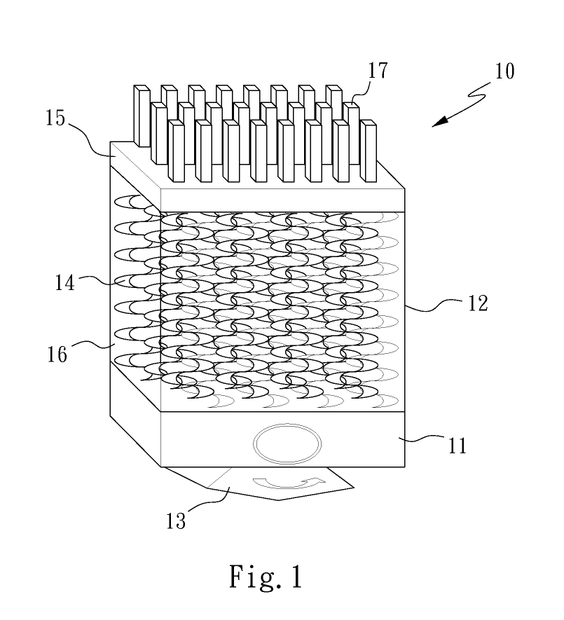

FIG. 1 is an illustrative view of an LHTES device in one embodiment of this invention. The LHTES device 10 generally comprises a chamber 12, a plurality of thermal conductivity enhancement units 14 disposed in the chamber 12, and phase change material (PCM) 16 filled in the chamber. The chamber 12 is preferably made of material having a desirable strength, being compatible with the PCM 16 contained therein, stable at the working temperature of the PCM 16, and thermally insulated, and it can be implemented as the enclosure of the LHTES device 10, such as a thermal battery, containing PCM.

The selection of the PCM 16, including those readily known in the art, such as hydrated salts, paraffin waxes, fatty acids, and eutectics of organic and non-organic compounds, is related to the desirable cabin temperature of the EV; however, in a situation where the PCM 16 is adapted for storage of coolness, the PCM 16 preferably has a phase change temperature ranging from −100 to 20° C. ; in a situation where the PCM 16 is adapted for storage of thermal energy, the PCM 16 preferably has a phase change temperature ranging from 20 to 500° C. In addition, from the perspective of high performance, material with a high energy density is preferred.

In consideration of the low thermal conductivity of some PCM 16, thermal conductivity enhancement units 14 are filled as fillers into the chamber 12 to facilitate retrieval and storage of thermal energy or coolness. Useful material for the thermal conductivity enhancement units 14 includes but not limited to graphite, carbon, thermally conductive metal, and the combination thereof, and the suitable shape thereof may be plate, coil, filament, strip, fiber, powder, pipe, or foam. As shown in FIG. 1, the thermal conductivity enhancement units 14 are in the form of regularly arranged and spirally elongated filaments, which can be prepared from low-cost stainless steel scrubbers or scourers.

In a preferred embodiment, the chamber 12 is enclosed between a first cover 11 and a second cover 15, which are respectively provided with a rotatable joint 13 and a plurality of fins 17. The rotatable joint 13 can be rotated to fit into a cold or hot junction surface of a thermal energy generation apparatus during the charging mode and depart therefrom to prevent heat backflow during the standby mode or driving mode; the fins 17 are surfaces extended from the second cover 15 used to increase the rate of heat transfer by enhancing convection. By the aforementioned structural design, thermal energy or coolness produced under the charging mode of an EV can be transferred via the first cover 11 to the PCM 16 and stored therein; under the driving mode when the driver turns on a ventilation device, thermal energy or coolness stored in the PCM 16 can be transferred to the second cover 15 and thence to the fins 17, at which heat exchange occurs, allowing thermally conditioned air to be introduced by the ventilation device into the cabin or the passenger compartment, so as to change the temperature thereof or maintain the temperature at a desirable degree. In one embodiment, for the purpose of efficient heat transfer, the first cover 11, the second cover 15, the rotatable joint 13, and the fins 17 are made of material with a high thermal conductivity.

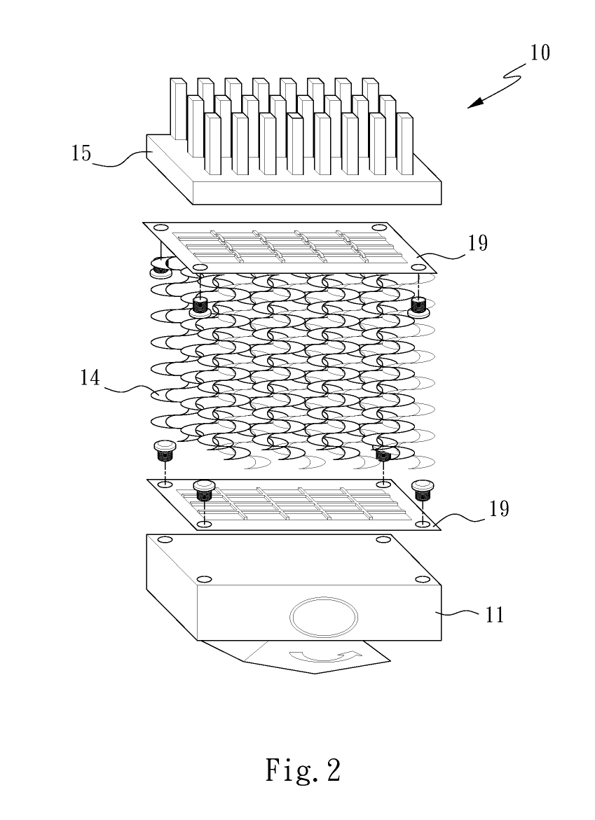

FIG. 2 is a partial exploded view of an LHTES device illustrating how to assemble an LHTES device in one embodiment of this invention. To provide an ordered arrangement of the thermal conductivity enhancement units 14 to facilitate uniform and efficient heat transfer, two grid plates 19 are used between which the thermal conductivity enhancement units 14 are secured in a longitudinal manner. In this embodiment, the thermal conductivity enhancement units 14 are prepared by elongating the stainless steel filaments of a kitchen scrubber or scourer generally used for washing pots or frying pans, thereby allowing substantial cost reduction. The grid plates 19 can then be respectively fastened to the first cover 11 and the second cover 15 by bolts, followed by forming an enclosure to contain the thermal conductivity enhancement units 14 and filling the space encompassed by the enclosure, the first cover 11, and the second cover 15 with phase change material.

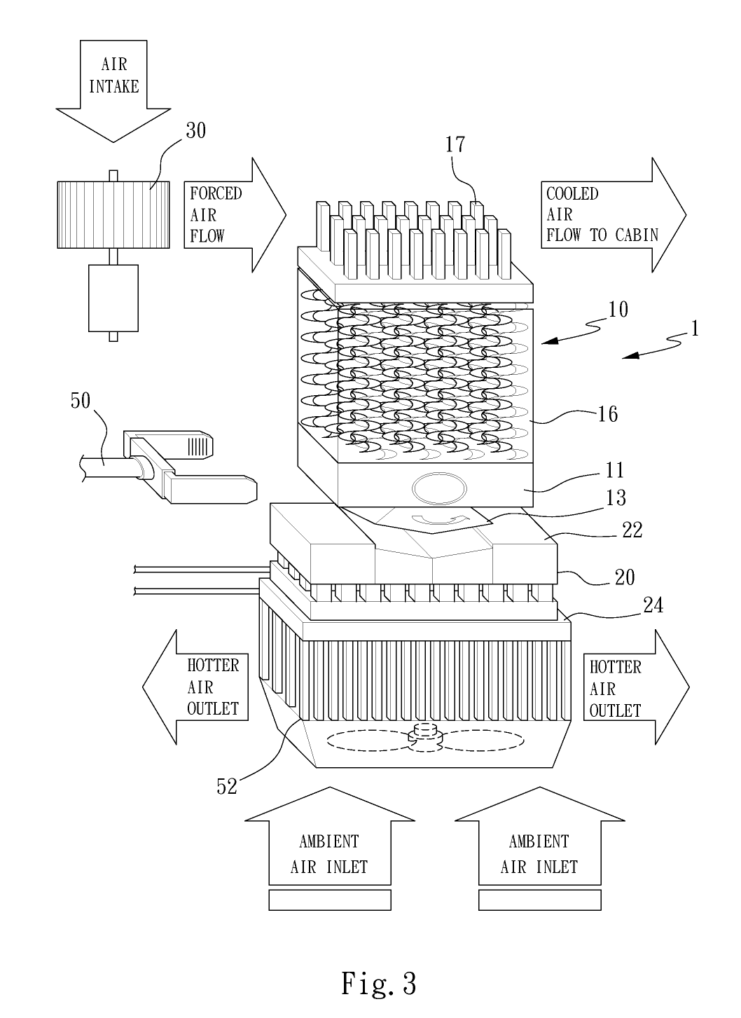

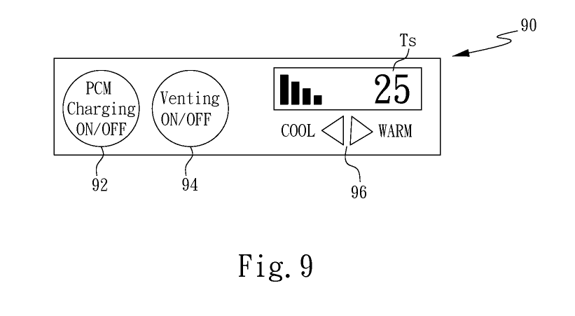

FIG. 3 is an illustrative view of an air-conditioning system in one embodiment of this invention employing the LHTES device. As shown, the air-conditioning system 1 comprises an LHTES device 10, a thermal energy generation apparatus 20, and a ventilation device 30. In this embodiment, a thermoelectric module, also known as a Peltier device, is used as the thermal energy generation apparatus 20 to generate thermal energy and coolness at two different sides respectively. As commonly known in the art, a thermoelectric module can comprise two ceramic plates with a bismuth telluride composition between the two plates. More particularly, for the purpose of this invention, the configuration of the thermoelectric module described and shown in, for example, FIG. 9A of U.S. Pat. No. 6,213,198 to Kazushi Shikata et al is herein incorporated by reference in its entirety.

It is further described below how the air-conditioning system 1 is operated under different modes to lower or maintain the temperature of the passenger compartment with PCM for storage of coolness. However, it should be understood that the air-conditioning system 1 can also be operated in a similar manner to increase or maintain the temperature of the passenger compartment as well with the use of PCM for storage of thermal energy.

When an EV containing the air-conditioning system 1 is operated under the charging mode, during which coolness is generated by the thermal energy generation apparatus 20, which is a thermoelectric module in this case, and saved or stored in the LHTES device 10, the LHTES device 10 is brought by a movement apparatus 50, such as a pneumatic control actuator already known in the art, like those disclosed in Automotive Air Conditioning and Climate Control Systems, pp. 19-20, which is herein incorporated by reference in its entirety, to closely contact the cold junction surface 22 of the thermoelectric module, for example, with its rotatable joint 13 rotated to fit with the cold junction surface 22. Thus, coolness generated by the thermal energy generation apparatus 20 is transferred to the first cover 11 and passed to and stored in the PCM 16. Meanwhile, it is preferable to have a heat dissipation device 52 in close contact with the hot junction surface 24 of the thermoelectric module, such that heat produced by the thermoelectric module during the generation of the coolness can be dispelled, for example by a heat sink and a blower of the heat dissipation device 52. The installation of the heat dissipation device 52 at one side (i.e. the hot junction surface 24) of the thermoelectric module, while having the LHTES device 10 at the other side (i.e. the cold junction surface 22), ensures a low temperature difference between two sides of the thermoelectric module and therefore a high working efficiency of the thermoelectric module. In addition, the ventilation device 30, a blower in this embodiment, is not actuated under the charging mode.

Once the LHTES device 10 has reached a predetermined temperature, which may be slightly lower than or equal to the phase change temperature of the PCM 16 for example, or when the PCM 16 therein has been provided with a sufficient amount of coolness in the form of latent heat, the operation of the air-conditioning system 1 is switched from the charging mode to the standby mode. In the standby mode, the LHTES device 10 is separated from the thermal energy generation apparatus 20, which has been switched off, by the movement apparatus 50 to prevent coolness stored in the PCM 16 from releasing via conduction with the thermal energy generation apparatus 20. Also, the ventilation device 30 and the blower of the heat dissipation device 52 are not in operation. Particularly, in the standby mode, a sensor (not shown) is employed to monitor the temperature of or the percentage of coolness stored in the LHTES device 10 to allow an operation corresponding to the temperature or the percentage of coolness. For example, when the temperature is higher than a predetermined value in the standby mode, the LHTES device 10 is again brought in contact with and charged by the thermal energy generation apparatus 20 until the sufficient amount of coolness is stored. Generally, the predetermined temperature is selected in correspondence with the phase change temperature of the PCM 16. For example, if the PCM 16 has a phase change temperature of −5° C., and the temperature at which the air-conditioning system 1 is switched to the standby mode is −10° C., the predetermined temperature may be −7° C. or −6° C. ; if the PCM 16 has a phase change temperature of −20° C., the predetermined temperature may be −23° C. or −22° C. In brief, the operation of the air-conditioning system 1 in the standby mode can be controlled according to the temperature of the LHTES device 10.

In the driving mode, the coolness stored in the PCM 16 is released from the LHTES device 10, which has been separated from the thermal energy generation apparatus 20. Through the large surface area provided by the fins 17, the coolness can be efficiently transferred to the airflow forced by the ventilation device 30, allowing cooled air to flow into the cabin. Therefore, with the proper design of the air duct and a corresponding control strategy, infra, the temperature of the cabin can be adjusted to or maintained at a desirable degree without substantially consuming the power stored in the battery pack of the EV, providing the driver and passengers with a pleasant driving experience while not compromising the trip range.

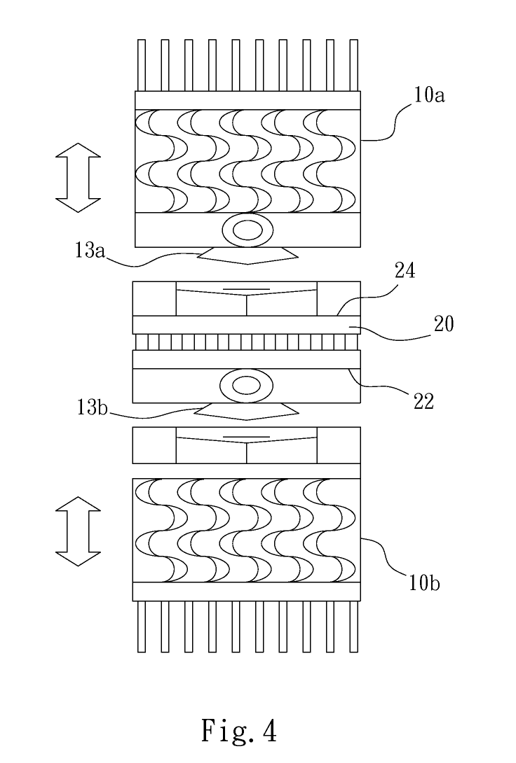

FIG. 4 is an illustrative view showing the use of two LHTES devices in one embodiment for air-conditioning In this embodiment, two LHTES devices 10a, 10b are filled with different kinds of PCM to store thermal energy and coolness respectively. Preferably, the LHTES device 10a above the thermal energy generation apparatus 20 is filled with PCM having a phase change temperature greater than 20° C. for thermal energy storage, and the LHTES device 10b below the thermal energy generation apparatus 20 is filled with PCM having a phase change temperature less than 20° C. for coolness storage, since this configuration prevents water drip or droplet formed by condensation of mist in the air from dribbling down and undesirably resulting in malfunction of electronic parts in the thermal energy generation apparatus 20. To prevent water drip or droplet from dribbling down onto water-sensitive electronic components of the EV, a water collection plate or tank (not shown) can be installed right below the LHTES device 10b. In addition, this embodiment provides various advantages over the embodiment with a single LHTES device. For example, in the charging mode, the two LHTES devices 10a, 10b are respectively in close contact with the hot junction surface 24 and cold junction surface 22 of the thermoelectric module, and thermal energy and coolness produced thereby can both be stored in the LHTES devices separately instead of retaining one and discarding the other, so the energy can be well exploited without waste. Moreover, the use of two LHTES devices with different PCMs allows users to selectively increase or decrease the cabin temperature in the driving mode.

As shown in FIG. 4, the rotatable joints 13a, 13b can be equipped on the LHTES device 10a or on the thermal energy generation apparatus 20, and the design and shape of the hot junction surface 24 and the cold junction surface 22 can be correspondingly altered or modified to allow efficient separation and combination of the LHTES devices 10a, 10b with the thermal energy generation apparatus 20. In addition, to further increase thermal conductivity, thermal grease, paste, or gel or equivalents thereof can be applied to the hot junction surface 24 and/or the cold junction surface 22.

To prevent heat exchange between thermal energy and coolness stored in different LHTES devices, in the driving mode the LHTES devices preferably operates in different, at least partially isolated spaces. A suitable air duct arrangement that meets the need mentioned above can be found in FIG. 1 of U.S. Pat. No. 6,213,198 to Kazushi Shikata et al, which is herein incorporated by reference in its entirety.

For the embodiments shown in FIGS. 1-4, the PCM used for the storage of coolness preferably has a phase change temperature greater than 0° C., and n-tetradecane, which has a phase change temperature of 6° C., can be the suitable material. If the phase change temperature of the PCM adopted by the previous embodiments is less than or equal to 0° C., the coolness released tends to freeze the mist in the air and leads to the formation of ice on the fins for heat exchange, i.e. ice-up of the fins. As a result, after operating for a period of time under the driving mode, the LHTES device(s) may not work as efficient as it does in the beginning because the airstream channel or space defined by the fins is gradually occupied and obstructed by ice. Hence, the selection of the PCM for coolness storage is limited, and many PCMs with high latent heat or energy density are unfortunately not applicable.

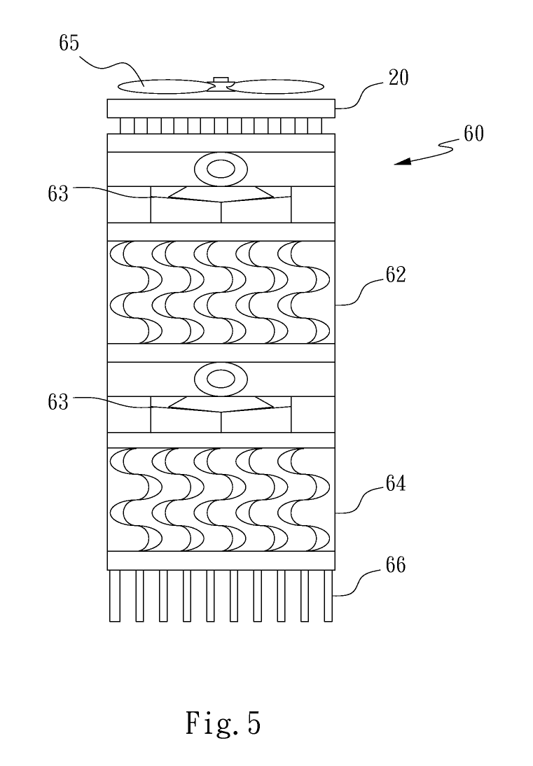

To address this issue and to break the limitation of PCM selection, one embodiment of this invention proposes a split-type LHTES system, particularly a split-type low temperature LHTES system, as shown in FIG. 5. In this embodiment, the split-type low temperature LHTES system 60 mainly comprises a first low temperature LHTES device 62 and a second low temperature LHTES device 64, both having a chamber, a plurality of thermal conductivity enhancement units disposed in the chamber, and PCM filled in the chamber. To facilitate separation and combination of the two low temperature LHTES devices, rotatable joints 63 can be provided to any one of the low temperature LHTES devices or to the thermal energy generation apparatus 20, which is a thermoelectric module in this embodiment. Preferably, the PCM of the second low temperature LHTES device 64 has a phase change temperature greater than 0° C., and the first low temperature LHTES device 62 has a phase change temperature less than 5° C. and a latent heat of fusion greater than 250 joules/gram. The purpose of keeping the temperature of the second low temperature LHTES device 64 greater than 0° C. is to prevent from ice-up of the fins 66. More preferably, the PCM used in the first low temperature LHTES device 62 may be water or other PCMs with a phase change temperature less than 0° C. In addition, the major difference between the two low temperature LHTES devices is that only the second low temperature LHTES device 64 is provided with fins 66.

In the charging mode, coolness produced by the thermoelectric module at one side is transferred to the first low temperature LHTES device 62 and thence to the second low temperature LHTES device 64 via the rotatable joint 63 therebetween by thermal conduction, and heat produced at the other side is dissipated by the blower 65 to ensure high operation efficiency of the thermoelectric module. Once a predetermined amount or percentage of coolness has been stored in the first low temperature LHTES device 62 and/or the second low temperature LHTES device 64, the operation of the split-type low temperature LHTES system 60 is switched to the standby mode, as mentioned above, in which the thermal energy generation apparatus 20 intermittently charges the two LHTES device according to the data provided by a sensor. In the driving mode, the second low temperature LHTES device 64 is employed to carried out heat exchange with the air blown by a ventilation device, such as a blower, and the first low temperature LHTES device 62 is employed as a reservoir for providing coolness to the second low temperature LHTES device 64 via thermal conduction or any other coolness transport means which can be understood by a person skilled in the art, such as a heat transfer device which comprises a circulation pipe connected between the low temperature LHTES devices and heat transfer fluid circulating therein. Instead of employing an extra thermoelectric module to produce thermal energy and/or coolness, this invention can also be integrated to the existing thermal energy generation system widely adopted by EVs, i.e. the vapor-compression refrigeration system, which mainly comprises a compressor, a condenser, an expansion valve, and an evaporator. Within the vapor-compression refrigeration system, the circulating refrigerant enters the compressor and is compressed to a higher pressure as well as a higher temperature. The hot, compressed vapor is then routed through the condenser and cooled and condensed into a liquid, and then the condensed liquid refrigerant is routed through the coil or tubes in the expansion valve where it undergoes an abrupt reduction in pressure. After that, the cold mixture is routed through the coil or tubes in the evaporator and then back into the compressor to complete the refrigeration cycle. The evaporator may comprise a serpentine tube provided therein with a plurality of refrigerant conduits and corrugated in a zigzag pattern and baffles interposed between opposed outer surfaces of the serpentine tube, as disclosed in U.S. Pat. No. 4,557,324 to Hiroshi Kondo et al, which is incorporated herein by reference in its entirety. Behind the evaporator, a fan is employed to force air across the coil or tubes carrying the cold refrigerant liquid and vapor mixture. The air evaporates the liquid part of the cold refrigerant mixture and is cooled at the same time to lower the temperature of the cabin when directed into the cabin.

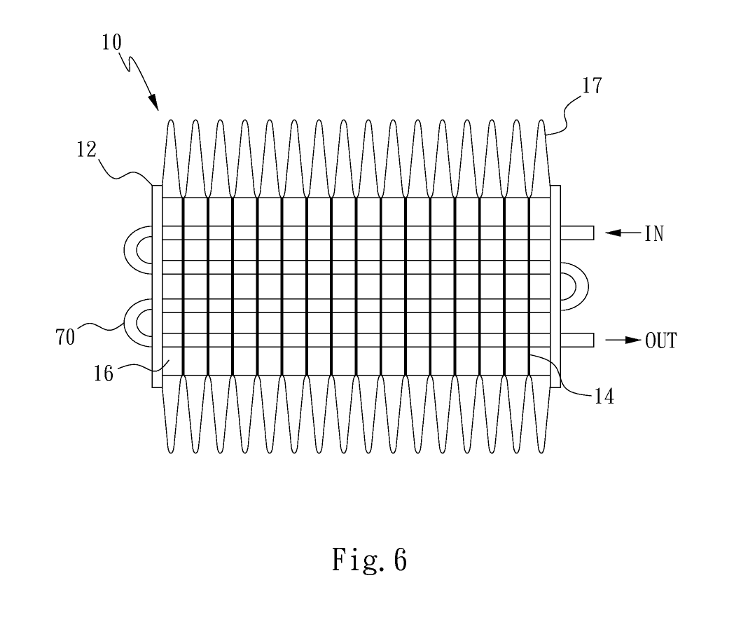

Refer to FIG. 6 for an illustrative view of one embodiment making use of an evaporator as a thermal energy generation apparatus for an LHTES device. In this embodiment, the LHTES device 10 generally comprises a chamber 12, PCM 16 filled in the chamber, and a plurality of fins 17 extended from the periphery of the chamber 12. Particularly, the chamber 12 is wrapped around at least part of an evaporator 70 having a serpentine tube bundle and baffles interposed between opposed outer surfaces thereof, such that the baffles are used as the thermal conductivity enhancement units 14 disposed in the chamber 12, and that the PCM 16 can be filled in the space defined by the thermal conductivity enhancement units 14.

In the charging mode, the vapor-compression refrigeration system containing the evaporator 70 is turned on, making the refrigerant circulate in the thermal cycle formed by the compressor, the condenser, the expansion valve, and the evaporator 70. When the low temperature refrigerant passes through the LHTES device 10, the coolness is transferred to and stored in the PCM 16. Once the charging is completed, the operation of the vapor-compression refrigeration system can be controlled according to the temperature or percentage of coolness stored in the PCM 16, which may be monitored by use of a sensor as described above. Accordingly, during the driving mode, a user can switch on a ventilation device, which may be the blower or fan disposed behind the evaporator 70, to force air through the fins 17, at which heat exchange occurs to lower the temperature of the air, and into the cabin. Therefore, unlike the conventional air-conditioning system of an EV which requires a substantial amount of energy from the battery pack to drive the compressor, the embodiment disclosed in FIG. 6 allows storage of coolness produced when the EV is being charged and retrieval of the coolness when the EV is under the driving mode without having to turn on the compressor. Furthermore, the LHTES device 10 can also be used for storage of thermal energy when integrated with a heat source of a HTF cycle, such as the condenser of the vapor-compression refrigeration system mentioned above or an independent thermal cycle using a heating coil as the heat source and liquid polyol as the HTF, in a similar configuration as disclosed in FIG. 6. Alternatively, the LHTES device 10 can be integrated with a heat core or heater used in heating the cabin of an EV.

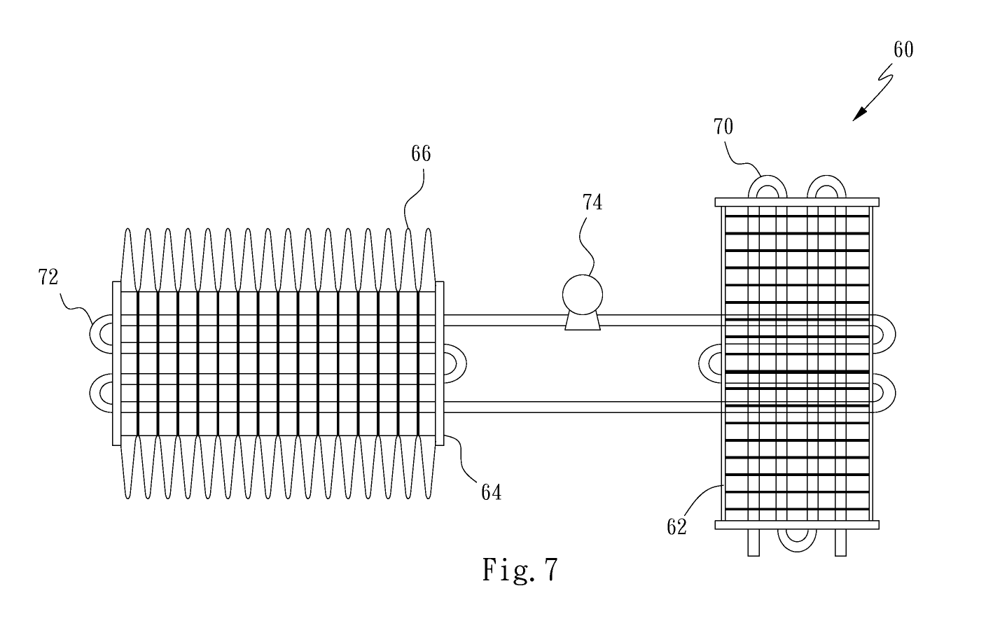

Similarly, to allow unlimited selection of PCM, the LHTES device using HTF for coolness or thermal energy exchange can also be implemented in a split-type low temperature LHTES system, as shown in FIG. 7, which is an illustrative view of a split-type low temperature LHTES system in one embodiment of this invention. In this embodiment, as in the embodiment shown in FIG. 5, the split-type low temperature LHTES system 60 mainly comprises a first low temperature LHTES device 62 and a second low temperature LHTES device 64, both having a chamber, a plurality of baffles disposed in the chamber used as thermal conductivity enhancement units, and PCM filled in the chamber. Preferably, the PCM of the second low temperature LHTES device 64 has a phase change temperature greater than 0° C., and the first low temperature LHTES device 62 has a phase change temperature less than 5° C. and a latent heat of fusion greater than 250 joules/gram. More preferably, the PCM used in the first low temperature LHTES device 62 may be water or other PCMs with a phase change temperature less than 0° C. In addition, the major difference between the two low temperature LHTES devices is that only the second low temperature LHTES device 64 has fins 66. In the charging mode, coolness carried by the refrigerant circulating in the evaporator 70 of a vapor-compression refrigeration system is transferred to and stored in the PCM of the first low temperature LHTES device 62, and thence transferred to the PCM of the second low temperature LHTES device 64 via the HTF such as refrigerant pumped by a pump 74 and circulating in the piping 72 between the first low temperature LHTES device 62 and the second low temperature LHTES device 64. Once a predetermined amount or percentage of coolness has been stored in the first low temperature LHTES device 62 and/or the second low temperature LHTES device 64, the operation of the split-type low temperature LHTES system 60 is switched to the standby mode, in which the vapor-compression refrigeration system is selectively driven to produced coolness according to the data provided by a sensor. In the driving mode, the second low temperature LHTES device 64 is employed to carried out heat exchange with the air blown by a ventilation device, such as a blower, through the fins 66, and the first low temperature LHTES device 62 is employed as a reservoir for providing coolness to the second low temperature LHTES device 64 via the piping 72 containing HTF driven by the pump 74.

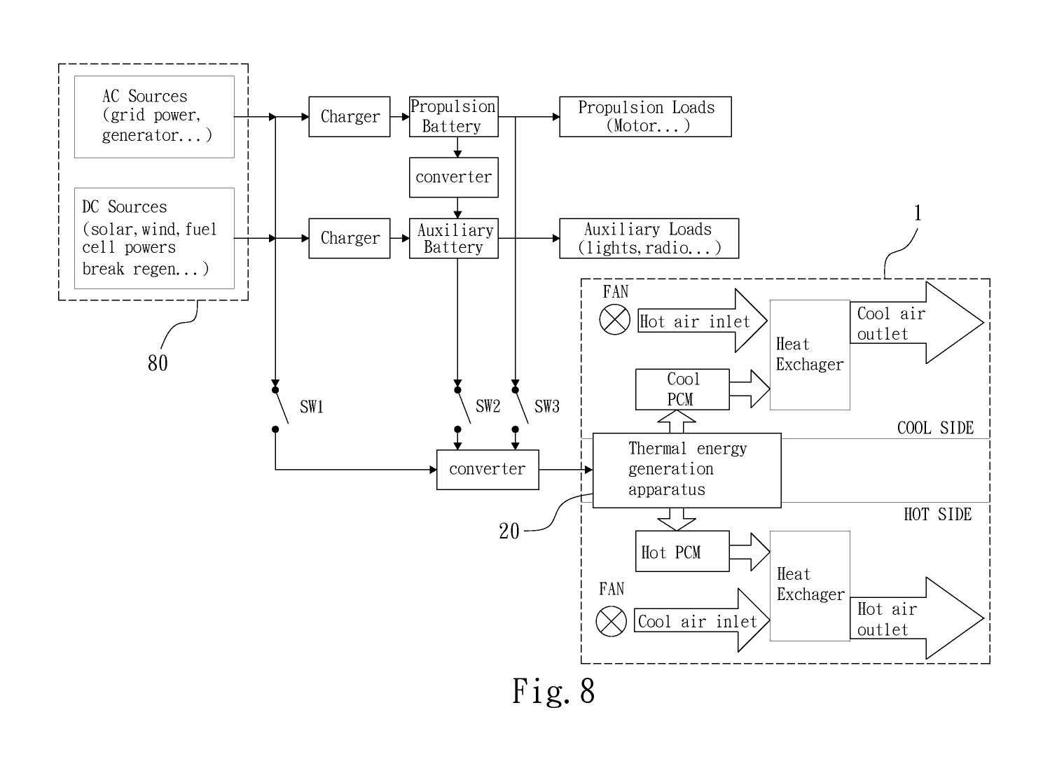

FIG. 8 is a block diagram showing an embodiment of the air-conditioning system of this invention integrated into an EV. The air-conditioning system 1, which is capable of providing thermally conditioned air to the passenger compartment, uses a thermal energy generation apparatus 20, such as a thermoelectric module or a vapor-compression refrigeration system, to generate thermal energy and/or coolness when the EV is being charged, such that the thermal energy and/or coolness can be stored in an LHTES device for later use when the EV is being driven without substantial consumption of power stored in the battery pack. The thermal energy generation apparatus 20 can be powered by an energy source 80. For example, AC sources, such as a grid power or power produced by a generator, and DC sources, such as solar power, wind power, or power produced by fuel cells, are all applicable energy sources for driving the thermal energy generation apparatus 20. As can be known by a person skilled in the art, the energy source 80 can also be adapted to charge the batteries of the electric vehicle, such as a propulsion battery and an auxiliary battery for propulsion loads (e.g. main motor) and auxiliary loads (e.g. compartment lights and radio) respectively. Before supplied to the thermal energy generation apparatus 20, the power from the energy source 80 may be converted by the converter, such as a DC-DC, DC-AC or AC-DC converter. When powered by the energy source 80, the thermal energy generation apparatus 20 can produce thermal energy in the form of coolness or thermal energy for storage in the PCM, either with a phase change temperature greater than 20° C. (hot PCM) or less than 20° C. (cool PCM), of at least one LHTES device of the air-conditioning system 1. In one embodiment, the air-conditioning system 1 comprises two LHTES devices respectively containing high temperature PCM and low temperature PCM. Therefore, thermal energy and/or coolness produced by the thermal energy generation apparatus 20 is converted into latent heat and stored in the PCM for later retrieval by air forced through a heat exchanger, such as the fins of the LHTES devices, and into the cabin. Preferably, the two LHTES devices are respectively used to store coolness and thermal energy, such that a user can choose to vent cool or hot air into the passenger compartment, depending on the temperature of the compartment and of the ambient. Furthermore, a plurality of LHTES devices may be employed at the cool side or the hot side; for example, more than one LHTES device can be adapted to store coolness at the cool side, as disclosed in the split-type low temperature LHTES system.

Therefore, unlike the conventional air-conditioning system of an EV, which consumes power stored in batteries when the EV is driven to supply power to all components of a vapor-compression refrigeration system, such as a compressor, a condenser, an expansion valve, and an evaporator and therefore greatly reduces the cruising range of the EV, the air-conditioning system 1 of this invention only requires very little power for driving a fan to blow air through an LHTES device or heat exchanger, thereby providing air conditioning without substantial consumption of the power stored in the batteries.

FIG. 9 is a front view showing a control panel of one embodiment of this invention. The control panel 90 comprises a PCM charging button 92, a venting button 94, a pair of temperature setting buttons 96, and a display showing the setting temperature Ts, which is 25 ° C. in this example. When the PCM charging button 92 is pressed or switched on preferably when the EV is being charged, a thermal energy generation apparatus may be turned on to produce coolness or thermal energy for storage by the PCM of an LHTES device. When the venting button 94 is pressed or switched on preferably when the EV is being driven, a ventilation device such as a blower or fan may be turned on to induce heat exchange between the LHTES device and the air forced through it so as to introduce the thermally conditioned air into the cabin. In addition, similar to the control panel of a conventional air-conditioning system of an EV, the temperature setting buttons 96 allow users to set the desirable temperature in the cabin, and the temperature value is shown on the display.

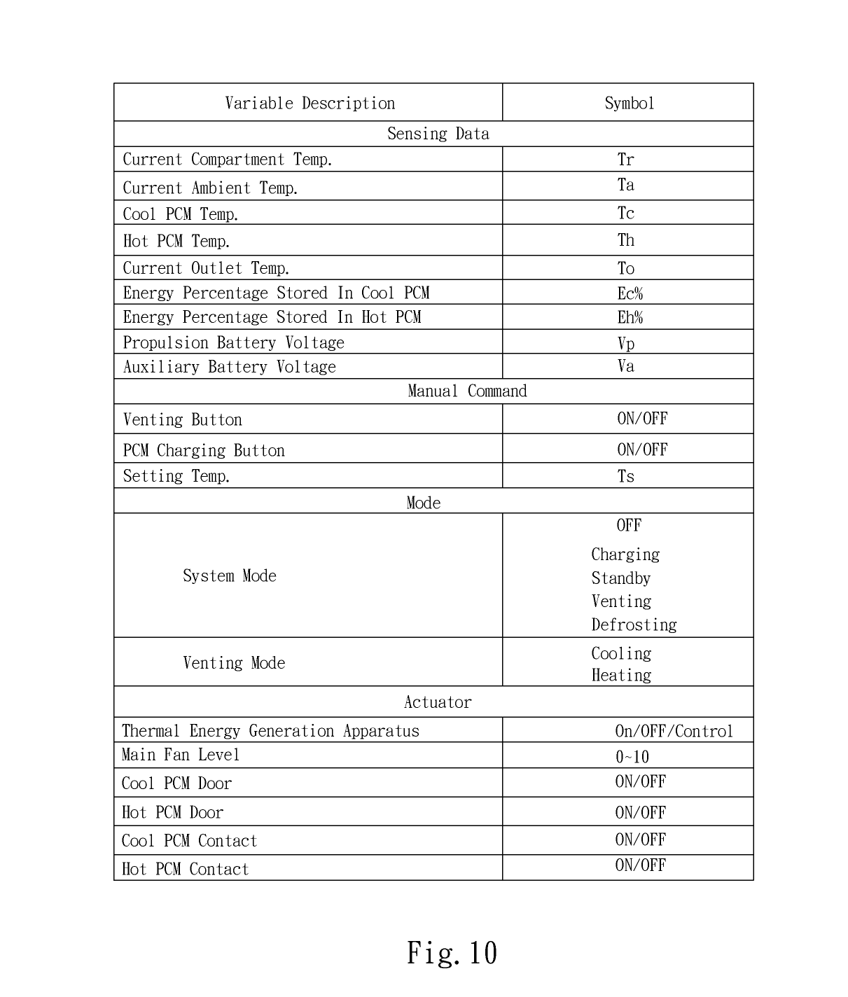

FIG. 10 is a table showing various system variables which may be used for the control of an air-conditioning system of one embodiment of this invention. A plurality of sensors are installed at different spots of an EV to sense or measure the sensing data, such as the temperature in the passenger compartment or cabin Tr, the ambient temperature Ta, the temperature of PCM with high or low phase change temperature Th or Tc, the temperature of the air forced by the ventilation device into the cabin To, the coolness or thermal energy percentage stored in the PCM Ec % or Eh %, and the voltage of batteries Vp and Va. The sensing data are used with the manual command to determine the system mode and the venting mode, and different actuators can then be controlled according to the system mode.

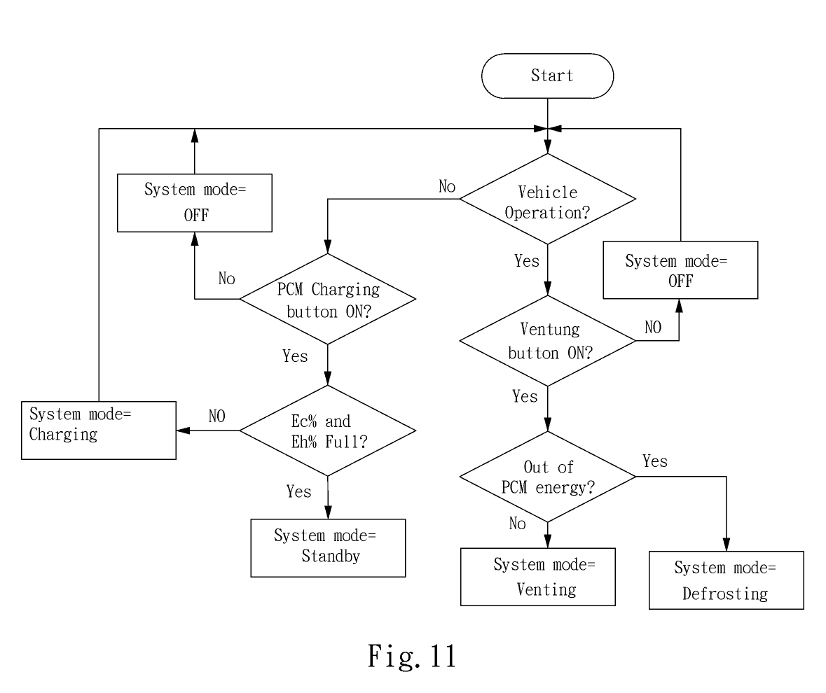

For better utilization and management of an air-conditioning system of one embodiment, this invention also discloses a control method suitable for any EV which employs an LHTES device as the temperature regulation means. FIG. 11 is a flow diagram showing the control algorithm for the determination of the system mode in one embodiment of this invention. As shown, the air-conditioning system of this embodiment can be operated under five different system modes, including off, charging, standby, venting, and defrosting. According to the data sensed by the sensors and the manual command, which are collectively used as the parameters representing the current state of the air-conditioning system, the control method of this embodiment is capable of determining the operation mode of the air-conditioning system. For example, when the vehicle is not in operation, the PCM charging button is pressed, and the energy storage percentage of the LHTES device is less than a predetermined value or not full, the operation mode of the air-conditioning system is charging, which means a thermal energy generation apparatus is powered by the energy source to produce thermal energy or coolness for storage in the LHTES device.

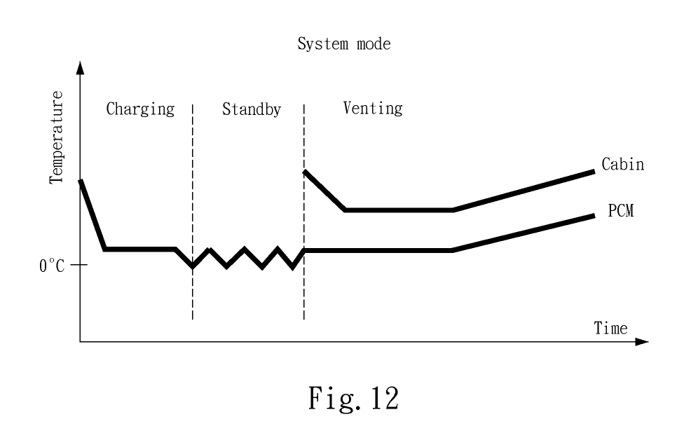

In the standby mode, as mentioned above, the operation of the thermal energy generation apparatus or the interaction between the thermal energy generation apparatus and the LHTES device is controlled according to the PCM temperature of the LHTES device or the percentage of coolness or thermal energy stored in the LHTES device. For example, when the temperature of PCM for storage of coolness is higher than a predetermined value in the standby mode, the thermal energy generation apparatus will be powered to supply coolness to the LHTES device until the sufficient amount of coolness is stored. Therefore, the temperature of the PCM in the standby mode may be fluctuant as shown in FIG. 12, which shows the temperature variation of the PCM under different modes.

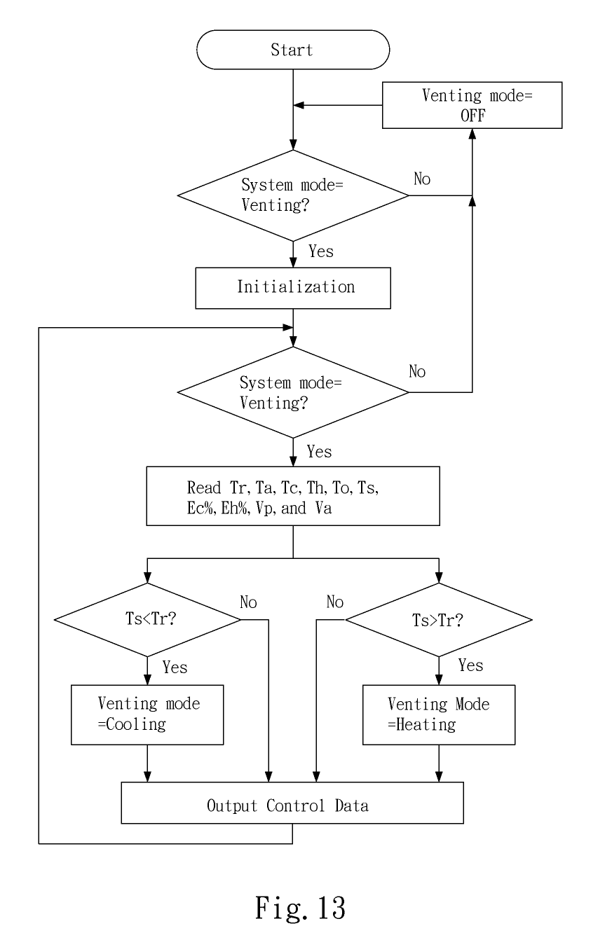

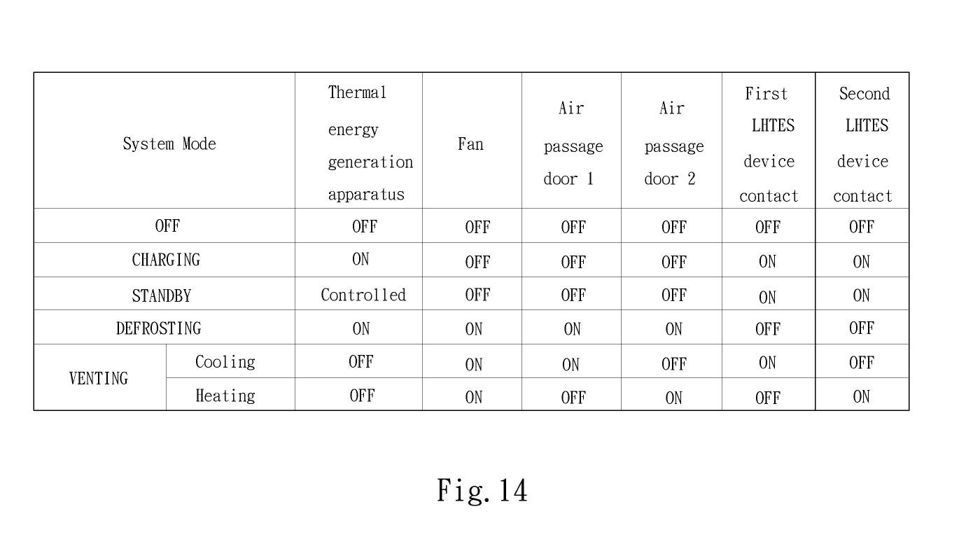

FIG. 13 is a flow diagram showing the control algorithm for the determination of different types of the venting mode in one embodiment of this invention. In an embodiment containing two LHTES devices for storing coolness and thermal energy respectively, the control method may further compare the compartment temperature and the setting temperature when the operation mode of the air-conditioning system is venting. For example, if the compartment temperature Tr is lower than the setting temperature Ts, which means a warmer compartment is desirable, an air passage door for the LHTES device for storing thermal energy is opened and an air passage door for the LHTES device for storing coolness is closed, such that air can be heated by the LHTES device after heat exchange and blown to the passenger compartment, and vice versa. Once the system variables are obtained and the operation mode determined, the control method may then control or actuate different actuators correspondingly, such as the thermal energy generation apparatus, the fan, the air passage doors, and the status of LHTES devices, in this example the contact status of LHTES devices with the thermal energy generation apparatus, which may be switched by a movement apparatus for bringing the LHTES devices into contact with the thermal energy generation apparatus and for separating the LHTES devices therefrom. To enable a person having ordinary skill in the art to fully exploit the present invention, the table of FIG. 14 shows how different actuators are operated under different modes, wherein air passage door 1 represents the passage door for the LHTES for storing coolness, air passage door 2 represents the passage door for the LHTES for storing thermal energy, and the first LHTES device and the second LHTES device represent the LHTES device for storing coolness and the LHTES device for storing thermal energy respectively; in addition, the rotation speed of the fan under the venting mode and the defrosting mode may be the same or different.

Although the invention has been described and illustrated in detail, it is to be clearly understood that the same is by way of illustration and example, and is not to be taken by way of limitation. The spirit and scope of the present invention are to be limited only by the terms of the appended claims.

What is claimed is:

1. A latent heat thermal energy storage (LHTES) device for an electric vehicle (EV) used to store coolness or thermal energy produced when the EV is being charged and to release the coolness or thermal energy to regulate the temperature of a passenger compartment of the EV, the LHTES device comprising a chamber, a plurality of thermal conductivity enhancement units disposed in the chamber, and phase change material (PCM) filled in the chamber.

2. The LHTES device of claim 1, wherein the chamber is enclosed and disposed between a first cover provided with a rotatable joint and a second cover provided with a plurality of fins.

3. The LHTES device of claim 2, wherein the first cover and the second cover are respectively attached by a first grid and a second grid between which the thermal conductivity enhancement units are secured longitudinally.

4. The LHTES device of claim 1, wherein the chamber is partially wrapped around an evaporator or a condenser of a vapor-compression refrigeration system.

5. The LHTES device of claim 4, wherein the chamber is partially surrounded by a plurality of fins.

6. The LHTES device of claim 1, wherein the thermal conductivity enhancement units are selected from a group consisting of graphite, carbon, thermally conductive metal, and the combination thereof

7. The LHTES device of claim 1, wherein the thermal conductivity enhancement units are in a shape of plate, coil, filament, strip, fiber, powder, pipe, or foam.

8. The LHTES device of claim 1, wherein the PCM is adapted for storage of coolness and has a phase change temperature ranging from −100 to 20° C.

9. The LHTES device of claim 1, wherein the PCM is adapted for storage of thermal energy and has a phase change temperature ranging from 20 to 500° C.

10. A split-type low temperature LHTES system comprising:
a first LHTES device comprising a chamber, a plurality of thermal conductivity enhancement units disposed in the chamber, and PCM having a phase change temperature less than 5° C. filled in the chamber; and
a second LHTES device in thermal connection with the first LHTES device, the second LHTES device comprising a chamber, a plurality of thermal conductivity enhancement units disposed in the chamber, PCM having a phase change temperature greater than 0° C. filled in the chamber, and a plurality of fins in thermal connection with the chamber.

11. The split-type low temperature LHTES system of claim 10, wherein the PCM of the first LHTES device has a latent heat of fusion greater than 250 joules/gram.

12. The split-type low temperature LHTES system of claim 10, wherein the PCM of the first LHTES device is water or has a phase change temperature less than or equal to 0° C.

13. The split-type low temperature LHTES system of claim 10, further comprising a heat transfer device for transferring coolness from the first LHTES device to the second LHTES device.

14. The split-type low temperature LHTES system of claim 13, wherein the heat transfer device comprises a circulation pipe connected with the first and second LHTES devices and heat transfer fluid circulating in the circulation pipe.

15. The split-type low temperature LHTES system of claim 10, wherein the thermal conductivity enhancement units of the first and second LHTES devices are individually selected from a group consisting of graphite, carbon, thermally conductive metal, and the combination thereof.

16. The split-type low temperature LHTES system of claim 15, wherein the thermal conductivity enhancement units of the first and second LHTES devices are individually in a shape of plate, coil, filament, strip, fiber, powder, pipe, or foam.

17. An air-conditioning system for providing thermally conditioned air into a cabin of an electric vehicle, comprising:
a thermal energy generation apparatus;
a first LHTES device filled with PCM in thermal connection with the thermal energy generation apparatus to store the thermal energy produced thereby; and
a ventilation device for driving air through the first LHTES device, by which the air is thermally conditioned, and into the cabin.

18. The air-conditioning system of claim 17, further comprising a movement apparatus adapted for bringing the first LHTES device into contact with the thermal energy generation apparatus and for separating the first LHTES device from the thermal energy generation apparatus.

19. The air-conditioning system of claim 17, wherein the thermal energy generation apparatus comprises a thermoelectric module with one side being opposite to the first LHTES device and provided with a heat sink.

20. The air-conditioning system of claim 17, further comprising a second LHTES device filled with PCM in thermal connection with the thermal energy generation apparatus to store the thermal energy produced thereby.

21. The air-conditioning system of claim 20, wherein the thermal energy generation apparatus comprises a thermoelectric module with an upper side and a lower side and the first and second LHTES devices are respectively disposed at the upper side and the lower side of the thermoelectric module.

22. The air-conditioning system of claim 21, wherein the PCM of the first LHTES device has a phase change temperature greater than 20° C., and the PCM of the second LHTES device has a phase change temperature less than 20° C.

23. The air-conditioning system of claim 20, wherein the first and second LHTES devices are individually provided with thermal conductivity enhancement units.

24. The air-conditioning system of claim 23, wherein the thermal conductivity enhancement units of the first and second LHTES devices are individually selected from a group consisting of graphite, carbon, thermally conductive metal, and the combination thereof and are individually in a shape of plate, coil, filament, strip, fiber, powder, pipe, or foam.

25. The air-conditioning system of claim 17, wherein the thermal energy generation apparatus comprises a vapor-compression refrigeration system.

26. The air-conditioning system of claim 25, wherein the first LHTES device is partially wrapped around an evaporator or a condenser of the vapor-compression refrigeration system.

27. The air-conditioning system of claim 25, wherein the first LHTES device is partially surrounded by a plurality of fins.

28. The air-conditioning system of claim 17, wherein the thermal energy generation apparatus comprises a heating coil.

29. An air-conditioning system for providing thermally conditioned air into a cabin of an electric vehicle, comprising:
the split-type low temperature LHTES system of claim 10;
a thermal energy generation apparatus in thermal connection with the first LHTES device; and
a ventilation device for driving air through the second LHTES device, by which the air is thermally conditioned, and into the cabin.

30. The air-conditioning system of claim 29, wherein the PCM of the first LHTES device has a latent heat of fusion greater than 250 joules/gram.

31. The air-conditioning system of claim 29, wherein the PCM of the first LHTES device is water or has a phase change temperature less than or equal to 0° C.

32. The air-conditioning system of claim 29, further comprising a heat transfer device for transferring coolness from the first LHTES device to the second LHTES device.

33. The air-conditioning system of claim 32, wherein the heat transfer device comprises a circulation pipe connected with the first and second LHTES devices and heat transfer fluid circulating in the circulation pipe.

34. The air-conditioning system of claim 29, wherein the thermal conductivity enhancement units of the first and second LHTES devices are individually selected from a group consisting of graphite, carbon, thermally conductive metal, and the combination thereof.

35. The air-conditioning system of claim 34, wherein the thermal conductivity enhancement units of the first and second LHTES devices are individually in a shape of plate, coil, filament, strip, fiber, powder, pipe, or foam.

36. A method of controlling the usage of at least one LHTES device of an electric vehicle, the LHTES device containing PCM and thermal conductivity enhancement medium, the method comprising:
(a) obtaining at least one state parameter;
(b) determining a usage mode of the LHTES device according to the state parameter collected; and
(c) actuating at least one of a thermal energy generation apparatus, a fan, a air passage door, and a movement apparatus of the electric vehicle according to the usage mode of the LHTES.

37. The method of claim 36, wherein the state parameter represents the state of vehicle operation, a charging switch, energy storage percentage, or a venting switch.

38. The method of claim 36, wherein the LHTES device is charged when the vehicle is not in operation, the charging switch is turned on, and the energy storage percentage is less than a predetermined value.

39. The method of claim 36, wherein the LHTES device is standby when the vehicle is not in operation, the charging switch is turned on, and the energy storage percentage is greater than a predetermined value.

40. The method of claim 36, wherein the LHTES device is in use for venting when the vehicle is in operation, the venting switch is turned on, and the energy storage percentage is greater than a predetermined value.

41. The method of claim 40, wherein the LHTES device is in use for venting hot air or cool air according to a comparison between a compartment temperature and a setting temperature.
